(19) United States
(12) Patent Application Publication
(10) Pub. No.: US 2007/0132990 A1
(43) Pub. Date: Jun. 14, 2007

(54) SURFACE INSPECTION APPARATUS

(75) Inventors: Yukiko Fukami, Kanagawa (JP); Toru Ishikura, Tokyo (JP); Hideo Mori, Kanagawa (JP)

Correspondence Address: DARBY & DARBY P.C., P. O. BOX 5257, NEW YORK, NY, 10150-5257, US

(73) Assignees: KIRIN TECHNO-SYSTEM CORPORATION, Yokohama-shi (JP); KTS OPTICS CORPORATION, Yokohama-shi (JP)

(21) Appl. No.: 11/561,950

(22) Filed: Nov. 21, 2006

(30) Foreign Application Priority Data
Nov. 24, 2005 (JP) 2005-338858
Nov. 24, 2005 (JP) 2005-338860

(51) Int. Cl. G01N 21/88

(52) U.S. Cl. 356/241.1

(57) ABSTRACT

In a surface inspection apparatus that receives, through receiving optical fibers, reflected light from light from a light source projected onto the surface of an article being inspected through a projection optical fiber and generates a two-dimensional image corresponding to the surface of that article being inspected based on the amount of that light received, a plurality of receiving optical fibers are disposed around the projection optical fiber and the diameter of those receiving optical fibers is greater than the diameter of the projection optical fiber.

### BACKGROUND OF THE INVENTION

1. Field of the Invention

The present invention relates to a surface inspection apparatus for inspecting foreign matter, fine grooves or scratches present on the surface of an article being inspected and inspecting grooves present on the inside surface of a cylindrical body being inspected.

2. Background Art

Typically, a concave part is formed on the inside surface of an automobile engine cylinder head, and a ring-shaped valve seat is installed in this concave part to assure the air tightness of the valves and durability. It is preferable for there to be absolutely no gap between the side surface of this concave part and the side surface of the valve seat, but a small gap actually arises because of manufacturing errors. Furthermore, because the desired engine performance cannot be obtained if this gap becomes large, there is a need to measure the width of this gap accurately.

Surface inspection apparatuses that receive, through a receiving optical fiber, light projected onto the surface of an article being inspected from a light source through a projection optical fiber, create a two-dimensional image corresponding to the surface of the article being inspected based on the amount of the light received and detect grooves and scratches on the surface are known for devices that can inspect for grooves and scratches present on the surface of the article being inspected. These devices are provided with a rotation means that rotates the light projected through the projection optical fiber along the inside periphery of the cylindrical body and a linear movement means that is moved in the axial direction of the cylindrical body and can inspect not only flat surfaces but also the inside surface of a cylindrical body.

For detection of minute grooves and scratches by this surface inspection apparatus, the projection optical fiber must be made thin, the exposure spot for the light made small and the resolution improved. However, if the exposure spot is made small, it is easily affected by light scattering caused by surface roughness and stain, and the problem of its being difficult to distinguish between the grooves one wants to detect and this roughness and stain arises. Therefore, it is difficult to use conventional surface inspection apparatuses for the detection of minute grooves.

In addition, the surface inspection apparatus described above may be automated for inspection without manual labor, and the inspection results are objective. However, since the values that are measured are only a two-dimensional image of the inside surface of the cylindrical body, it is further necessary to have a means for automatically detecting the width of grooves to construct a system for in-line use that removes bad products where grooves are of a prescribed width or greater.

### SUMMARY OF THE INVENTION

It is an object of the present invention to provide a surface inspection apparatus which is not affected by surface roughness, stain or the like and is capable of inspecting for fine grooves and other defects in the surface of the article being inspected. In addition, it is another object of the present invention to provide a surface inspection apparatus that inspects for grooves on the inside surface of a cylindrical body and has a means capable of determining the size of a groove from the results of that inspection.

A surface inspection apparatus according to an embodiment of the present invention solves the problems described above by receiving, through a receiving optical fiber, light projected onto the surface of an article being inspected from a light source through a projection optical fiber, having a plurality of those receiving fibers disposed around the projection optical fiber in the surface inspection apparatus that inspects the surface of the article being inspected based on the amount of that light received and making the diameter of these receiving optical fibers larger than the diameter of the projection optical fiber.

As discussed above, if the projection optical fiber is made thin to increase the resolution in the surface inspection apparatus, the light scattering because of roughness and stain present on shallow parts of the surface has a large effect on the reflected light. However, even in this case, the amount of specular reflection is larger and the spread of the scattered light from the position of the projection is smaller than the reflected light from a groove or scratch part. The surface inspection apparatus according to an embodiment of the present invention has a larger light receiving surface area than the conventional because a plurality of receiving optical fibers is disposed around the projection optical fiber and the diameter of the receiving optical fibers is larger than that of the projection optical fiber. Therefore, the amount of specular reflection is large and the spread of the scattered light is comparatively small, and with light reflected from rough or stained parts, it is possible to pick up a large proportion of the total reflected light. Conversely, the light scattered from grooves and scratches on the surface has little specular reflected light and a large spread in the scattered light, so even if the receiving light surface is expanded, the proportion of the increase in the amount of light received is smaller than with surface roughness and stain. That is, according to a surface inspection apparatus according to an embodiment of the present invention, it is possible to greatly increase the amount of light received from rough and stained parts without increasing the amount of reflected light from grooves and scratches very much. Therefore, it is possible to clearly discriminate between parts where roughness or stain are present and parts where grooves or scratches are present.

In addition, in an embodiment of the present invention, there may be provided a nonlinear amplification means where a photo-electric conversion of the light received from the receiving optical fibers is carried out and the signal after the photo-electric conversion is amplified nonlinearly. It is possible to discriminate parts with grooves or scratches from surface roughness or stain even if the resolution is improved by increasing the light receiving surface area as described above. However, even in such cases, the boundary between the output signal corresponding to the light received from parts with grooves or scratches after photo-electric conversion and the output signal corresponding to the light received from parts with surface roughness or stain is in a part where the signal strength is lower than the output signal corresponding to the light received from the parts where the surface is smooth and not stained. Therefore, if nonlinear amplification is carried out on the signal after photo-electric conversion such that there is a large amplification in the range where the output signal is low as in the present embodiment, it is possible to discriminate between surface grooves or scratches and surface roughness or stain.

The signal after photo-electric conversion described above is a voltage signal, and the amplification of the nonlinear amplification means described above may be made large in the low-voltage parts and small in the high-voltage parts. In addition, a logarithmic amplifier may be provided for that nonlinear amplification means. Accordingly, if nonlinear amplification is carried out as has been described above on the voltage signal after photo-electric conversion such that there is a large amplification low-voltage part where the output voltage is low, it is possible to discriminate between surface grooves or scratches and surface roughness or stain.

The article being inspected is the inside surface of a cylindrical body, and there may be provided a rotation means that rotates the light projected from the projection optical fiber along the inside periphery of that cylindrical body, a linear movement means that is moved in the axial direction of that cylindrical body, a clock signal generation means that generates a clock signal corresponding to the rotation of that rotation means, and an A/D conversion means that carries out A/D conversion of the amplified electric signal in synchrony with that clock signal. Accordingly, it is difficult for the two-dimensional image to be affected by rotational variations because the amplified electric signal is A/D converted based on the clock signal from the signal generation means.

The article being inspected may be an engine cylinder head, the surface of that article being inspected the inside surface of that cylinder head and the grooves and scratches gaps between the side surface of a concave part provided on that inside surface and the side surface of a valve seat inserted into that concave part. Accordingly, inspections of fine surface grooves and scratches on the inner surfaces of engine cylinder heads that are not affected by surface roughness and stain are possible.

A surface inspection apparatus according to another embodiment of the present invention solves the problems described above by being provided with an inspection part that has a light projection/receiving part and is inserted into the inside of the cylindrical body that is being inspected; there being advancement relative to the direction of the axial line along with the relative rotation of this inspection part centered on the axial line of the cylindrical body; the reflected light being received while light is projected onto the inside surface of the cylindrical body by the light projection/receiving part; the two dimensional image being represented by the coordinates of the groove in the direction of length and the coordinates of the groove in the direction of width in a surface inspection apparatus that generates a two-dimensional image corresponding to that inside surface based on the amount of light; finding a point corresponding to one edge part of the groove, where the amount of light exceeds a specified threshold value, and the width coordinate at with another point corresponding to the other edge part of this groove while moving along the coordinates in the direction of width with the coordinate in the direction of length fixed; and there being a groove determination means having an algorithm for finding the groove width for that section from the width coordinate for that one point and the width coordinate of that other point.

According to the surface inspection apparatus described above, there is a groove width determination means that has an algorithm that determines the representative width within the section being inspected from the two-dimensional image of the inside surface of this cylindrical body, so the width of the groove within that section may be determined automatically and objectively.

In another embodiment of the present invention, a range of the least one part of the groove in the direction of length may be set as the target section, and within this section, the coordinate of the previously described one point in the direction of width and the coordinate in the direction of width of the previously described other point may each be found for a plurality of coordinates in the direction of length; out of the coordinates in the direction of width for the one point found for each of the coordinates in the direction of length, the coordinate in the direction of width that has the most points may be made the representative coordinate for one side edge part; out of the coordinates in the direction of width for the other point found for each of the coordinates in the direction of length, the coordinate in the direction of length holding the most points may be made the representative coordinate for the other side edge part; and the groove width for the section may be set as the difference between the representative coordinate for that one side edge part and the representative coordinate for that other side edge part.

Since the groove width is determined based on the coordinate having the greatest number out of the plurality of points found in the section targeting a range with at least part of the direction of the length, it is possible get a grasp on the average groove width in that section.

In another embodiment of the present invention, the section described above may be a plurality of sections. Accordingly, since the groove width is determined for a plurality of sections, it is possible to get a grasp on the variation in that groove width when groove width is not fixed in the longitudinal direction. In addition, the plurality of sections described above may be equal intervals.

When the groove described above is present along the circumferential direction of the inside surface of the cylindrical body, the direction of the width of the groove is the axial direction for the cylindrical body, and the direction of the length of the groove is the circumferential direction of the inside surface of the cylindrical body. Accordingly, the width of a groove present in the circumferential direction on the inside surface of the cylindrical body may be determined automatically and objectively.

Furthermore, the cylindrical body in another embodiment of the present invention may be a cylinder head in an internal combustion engine for a vehicle, and the groove may be the space between a valve seat inserted into a concave part provided on the inside surface of that cylinder head and that concave part. Accordingly, the width of the space between the valve seat and the concave part may be determined automatically and objectively.

In addition, in another embodiment of the present invention, when the groove is present along the axial direction of the cylindrical body, the direction of the width of that groove is the circumferential direction on the inside surface of the cylindrical body, and the direction of the length of the groove is the axial direction for the cylindrical body. Accordingly, the width of a groove present along the axial direction on the inside surface of the cylindrical body may be determined automatically and objectively.

The two-dimensional image described above may be an image generated by a signal where the signal based on the amount of light received is processed by a Fourier transform, has the high-frequency components cut off and is further processed by an inverse Fourier transform. In addition, the two dimensional image described above may be an image generated by a signal where the signal based on the amount of light received is processed by a low-pass filter. Accordingly, it is possible to eliminate the effects of light scattering because of surface roughness and stain and the effects of other noise and carry out more accurate groove width determination.

### BRIEF DESCRIPTION OF THE DRAWINGS

In the appended drawings:

FIG. 1 is a schematic drawing of an embodiment of a surface inspection apparatus of the present invention;

FIG. 2 is a drawing showing the constitution of an embodiment of an inspection part;

FIG. 3A is a cross-sectional diagram of a projection optical fiber and receiving optical fibers;

FIG. 3B is a cross-sectional diagram of a projection optical fiber and receiving optical fibers for another embodiment;

FIG. 4 is a block diagram of a computation unit in the surface inspection apparatus according to an embodiment of the present invention;

FIG. 5 is a flow chart showing the algorithm that determines the groove width for each divided section;

FIG. 6A is a schematic drawing of an automobile cylinder head;

FIG. 6B is a drawing showing the application of the surface inspection apparatus to an intake port;

FIG. 7 is a graph showing the nonlinear amplification with a nonlinear amplifier;

FIG. 8 is a two-dimensional image where the space between the concave part on the inside circumference of an engine cylinder and a valve seat was inspected by a surface inspection apparatus according to an embodiment of the present invention;

FIG. 9 is an image where the image in FIG. 8 has undergone binary processing; and

FIG. 10 is an image where the image in FIG. 9 has undergone edge processing and been divided.

### DESCRIPTION OF THE PREFERRED EMBODIMENT

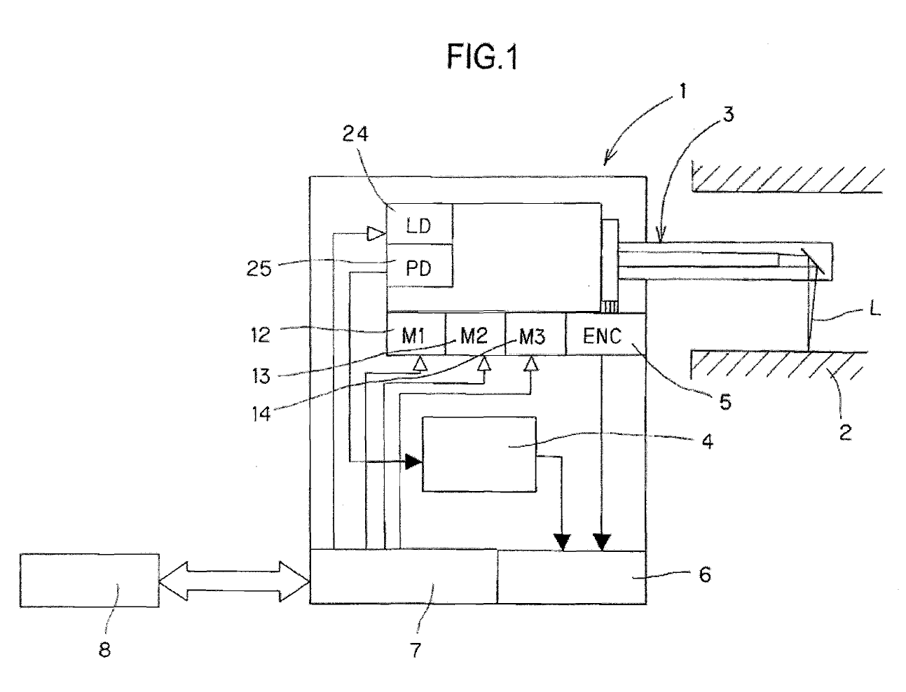

FIG. 1 is a schematic diagram of a surface inspection apparatus according to an embodiment of the present invention. As is shown in the drawing, a surface inspection apparatus 1 is inserted into a cylindrical body 2 and is provided with an inspection part 3 that receives the reflected light while projecting light L onto the inside surface of the cylindrical body 2, a non-linear amplifier 4, which is the nonlinear amplification means that amplifies the received light nonlinearly, an A/D converter 6, which is the A/D conversion means that performs an A/D conversion on a signal sent from the nonlinear amplifier part 4 using a sampling clock signal from an encoder 5, which is the clock signal generation means, a control part 7 that carries out various types of control on the inspection part 3 and the A/D converter 6, and a computation processing part 8 that carries out these various types of control and other processing that will be described later.

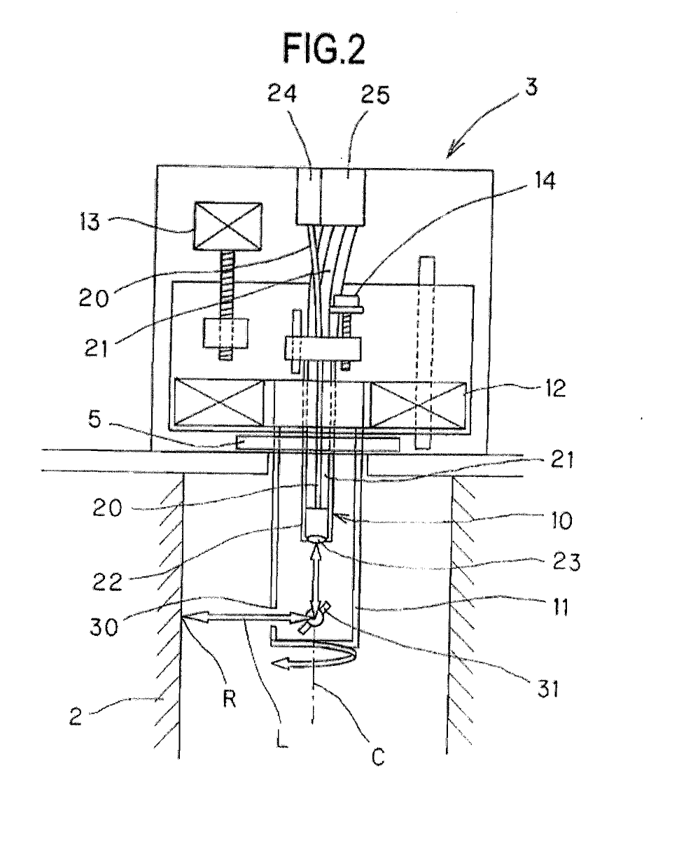

FIG. 2 is a drawing showing the constitution of the inspection part 3 schematically. As is shown in the drawing, the inspection part 3 is provided with a laser diode (hereinafter denoted LD) 24, which is the light source, a photodetector (hereinafter denoted PD) 25, a sensor head 10 that transmits light to the LD 24 and the PD 25, an outer casing 11 that surrounds the outside of the sensor head 10, a rotating mechanism 12 that is the rotation means that rotates the outer casing 11, a linear movement mechanism 13 that is the linear movement means that moves the outer casing 11 in and out, an encoder 5 that generates the sampling clock signal according to the rotation and a sensor head adjustment mechanism 14 that moves the sensor head 10 and focuses the light.

The sensor head 10 is provided with a projection optical fiber 20 and receiving optical fibers 21, a retention tube 22 that holds this projection optical fiber 20 and plurality of receiving optical fibers 21, and a convex lens 23 that is attached to the end of the retention tube 22 condenses the light from the projection optical fiber 20 to the outside and condenses the light from the outside to the inside. Furthermore, the base end of the projection optical fiber 20 is connected to the LD 24, and the base ends of the receiving optical fibers 20 [should be 21] are connected to the PD 25. Furthermore, the light generated by the LD 24 is projected toward the convex lens 23 through the projection optical fiber 20, and the light that is incident from the convex lens 23 is transmitted to the PD 25 through the receiving optical fibers 21.

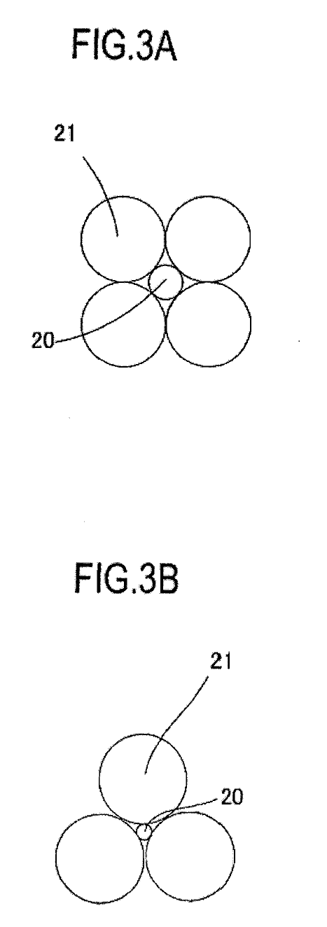

FIG. 3A shows a cross-sectional diagram of the projection optical fiber 20 and the receiving optical fibers 21 inside the retention tube 22. As is shown in the drawing, four receiving optical fibers 21 are disposed around one projection optical fiber 20, and furthermore, since the diameters of the receiving optical fibers 21 are larger than the diameter of the projection optical fiber 20, the light receiving surface area is larger than the light projection surface area. Moreover, the number of receiving optical fibers disposed around the projection optical fiber is not limited to four, and it is sufficient that it be a plural number; for example, three receiving optical fibers may be disposed around the one projection optical fiber, as is shown in FIG. 3B.

Returning to FIG. 2, the outer casing 11 covering the outside of the sensor head 10 is disposed coaxially to the sensor head 10, and the projection/receiving part 30 has an opening so that light may pass through the side part of the end [of the outer casing 11]. In addition, a reflecting mirror 31 is attached at a 45° angle to the axial line C of this outer casing 11 on the end part of the inside part of the outer casing 11. The light passing through the convex lens 23 of the sensor head 10 is bent at a right angle by this reflecting mirror 31, and forms the light projected onto an inspection region R on the inside of the cylindrical body 2. In addition, the light reflected from the inspection region R passes through the projection/receiving part 30, is bent at a right angle by the reflecting mirror 31, passes through the convex lens 23 and is transmitted to the receiving optical fibers 21.

On the other hand, the rotating mechanism 12 attached to the base end side of the outer casing 11 includes a rotating motor, and when the outer casing 11 is rotated by this rotating mechanism 12, the reflecting mirror 31 which is affixed to that outer casing 11 also rotates, and the position of the inspection region R rotates along the circumferential direction on the inside surface of the cylinder called body 2. Furthermore, when the outer casing 11 is rotated one time, the inspection region R goes around the inside surface of the cylindrical body 2 once, and a sample length clock signal matched to that rotation is generated by the encoder 5.

In addition, a linear motor or the like for the linear movement mechanism 13 is attached to the inspection part 3 and is such that the outer casing 11 may be moved in and out along the axial direction C of the cylindrical body 2. By this means, along with inspection following the circumferential direction on the inside surface of the cylindrical body 2, the light from the projection/receiving part 30 also moves relative to the axial direction and may inspect the entirety of the inside surface of the cylindrical body 2 over a wide range.

Returning to FIG. 1, the light transmitted from the receiving optical fiber 21 undergoes photo-electric conversion by the PD 25 and is converted into a voltage corresponding to the amount of light received. Furthermore, the nonlinear amplifier 4 connected to the PD 25 amplifies the voltage from the PD 25 nonlinearly, and there is a logarithmic amp (not shown in the drawing); here, the low-voltage parts are amplified greatly and the high-voltage parts are amplified little.

Moreover, a fast Fourier transform device, a low-pass filter and an inverse Fourier transform device may be disposed after this non-linear amplifier 4. Alternatively, a low-pass filter only may be disposed after the non-linear amplifier 4. By this means, the effects of light scattering by the surface roughness and stain that often appear in high frequency regions and the effects of other types of noise may be eliminated. For example, when a fast Fourier transform device, a low-pass filter and an inverse Fourier transform device are disposed and when the time for one circumferential inspection is set at 20 ms, cutoff at 0.2 ms, which is 1/100 of that, a low-pass filter of 5000 Hz for the frequency, is effective.

The nonlinear amplifier 4 is further connected to the A/D converter 6 directly, a fast Fourier transform device, a low-pass filter and an inverse Fourier transform device or a low-pass filter, and during this A/D conversion period, the signal is sampled according to the sampling clock generated by the encoder 5 and undergoes A/D conversion. The sampled digital signal is recorded on a storage device in the computation processing part 8. Moreover, the control part 7 controls the LD 24, rotating mechanism 12, linear movement mechanism 13 and sensor head adjustment mechanism 14.

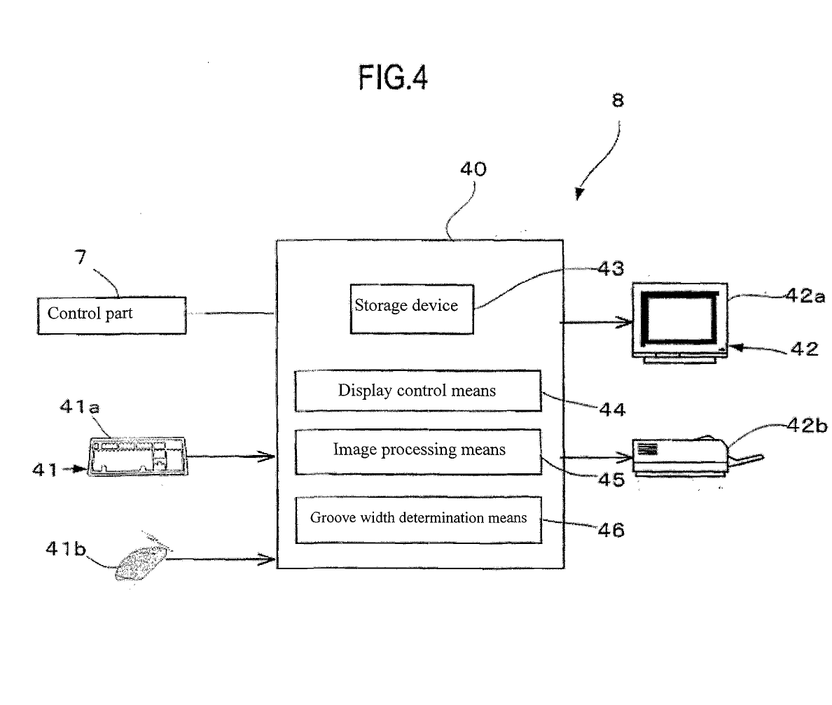

FIG. 4 is shows a block diagram of the computation processing part 8 connected to the control part 7. As is shown in the drawing, this computation processing part 8 is provided with a computation device 40, a keyboard 41a and mouse 41b as input devices 41 for the computation device 40, and a monitor 42a and printer 42b as output devices 42 as necessary. In addition, the computation device 40 includes a computer unit provided with, for example, a microprocessor, storage device 43 (RAM and ROM) necessary for the operation thereof and other peripheral devices, and for example, a personal computer may be used.

This computation device 40 is equipped with a display control means 44 that displays the digital signal corresponding to the amount of light received, which is sampled according to the rotational movement as described above and stored in the storage device 43, as the intensity of the brightness of the picture elements in a two-dimensional plane where the position in the circumferential direction on the inside surface of the cylindrical body 2 is set as the x-coordinate and the position in the lengthwise direction of the inside surface of the cylindrical body 2 as the y-coordinate. In addition, there is also provided an image processing means 45 that performs binary conversion, edge processing and the like on the two dimensional image that is displayed.

Furthermore, this computation device 40 is provided with a groove width determination means 46 for finding the width of grooves on the inner surface of the cylindrical body 2. This groove width determination means 46 performs a binary conversion on the two-dimensional image that shows the amount of light received as the intensity of the brightness in the picture elements, divides an image where that image has further undergone edge processing along a straight line extending in the y direction into a plurality and determines the groove width for each of the divided sections. Moreover, an edge processed image is divided in the present embodiment, but it is not limited to this, and a two-dimensional image that shows the intensity of the amount of light received or a binary converted image thereof may also be divided.

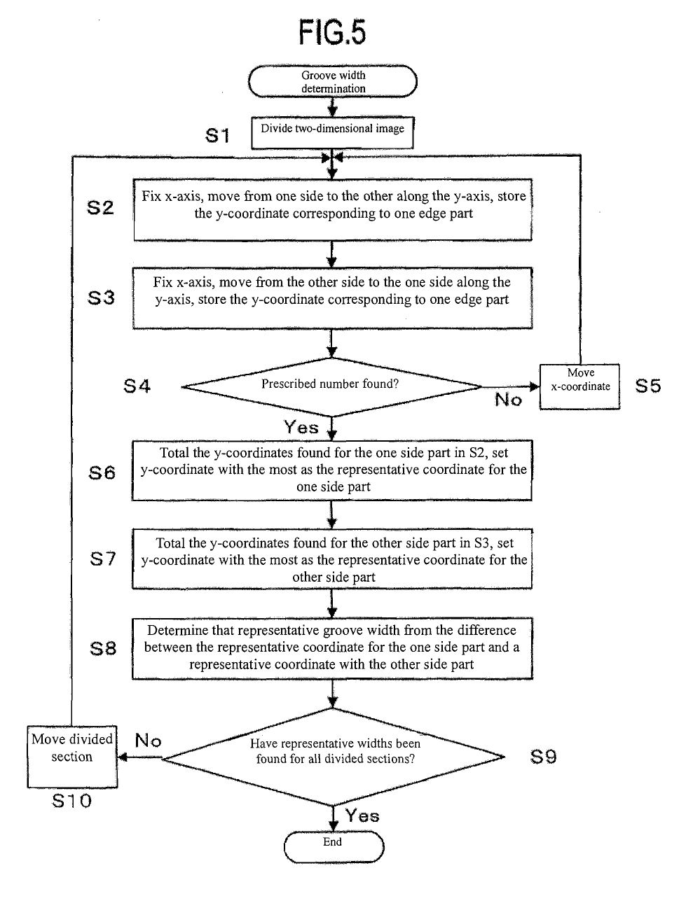

FIG. 5 is a flowchart showing the algorithm that determines the groove width for each section divided by the groove width determination means 46. First of all, in step 1 in this flowchart, the two-dimensional image plane is divided into a plurality along a straight line extending in the y direction based on the instructions for the number of divisions and the like that the operator inputs from the input device 41. In step 2, the x-axis coordinate is fixed at one point in one divided section; there is movement toward the groove from one side of the groove along the y-axis, and a point where a specific threshold value is exceeded between the brightness of a picture element and that of the adjacent picture element is searched for; the y-coordinate at that time is recorded as the y-coordinate corresponding to one edge part of a groove. In step 3, there is movement toward the groove from the other side of the groove along the y-axis with the same x-axis coordinate, and another point where the specific threshold value is exceeded for the change between the brightness of a picture element corresponding to the amount of light received and that of the adjacent picture element is searched for; the y-coordinate at that time is recorded as the y-coordinate corresponding to the other edge part of the groove. In step 4, whether the number of y-coordinates for both sides have been found for of all of the x-coordinates that should be searched in the one divided section as set in advance by the operator is examined. Furthermore, when the prescribed number is not found, it moves to step 5, and the x-coordinate is moved within the same divided section, with a return to step 2. Then the operations from step 2 through step 4 are repeated. If y-coordinates are found for both side parts for each of the prescribed number of x-coordinates, the process moves to step 6. In step 6, the y-coordinates for the plurality of edge parts on one side that were recorded in step 2 are totaled, and of those, the y-coordinate with the greatest total number is made the representative coordinate for the one side part. In step 7, the y-coordinates for the plurality of edge parts on the other side that were recorded similarly in step 3 are totaled, and of those, the y-coordinate with the greatest total number is made the representative coordinate for the other side part. In step 8 the difference between the representative coordinate for that one side part and the representative coordinate for the other side part is found, and that difference is set as the representative groove width for that divided section and stored. In step 9, whether the representative groove width has been determined for all divided sections is examined, and when a determination has not been made for all divided sections, the divided section is moved by step 10 and the process returns to step 2. When the representative groove widths have been determined for all divided sections, the flowchart ends. Then the computation results are output on an output device such as a suitable monitor.

Next, the case where the width of the gap between the side surface of the concave part formed in the inside surface of an automobile engine cylinder head and the side surface of a ring-shaped valve seat attached in that concave part is inspected by the surface inspection apparatus of the present embodiment and that width measured will be described.

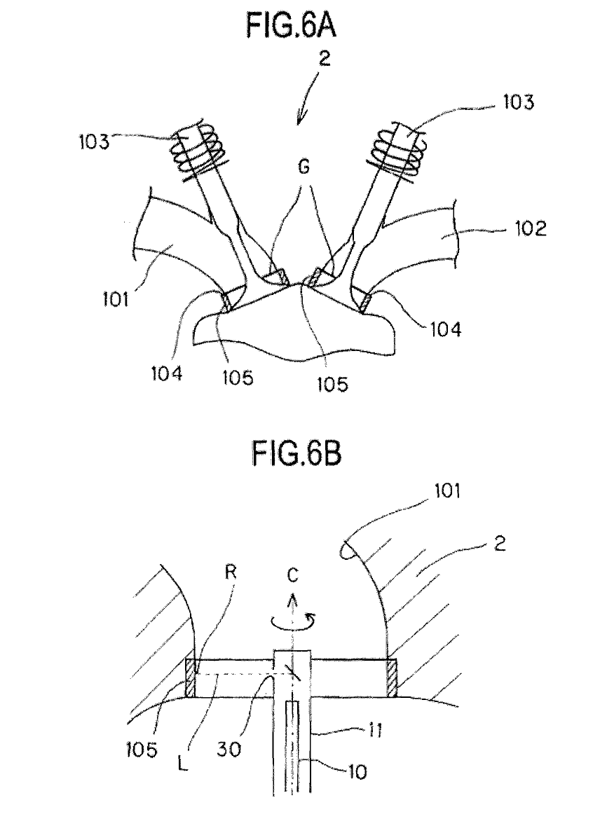

FIG. 6A is a schematic drawing of an automobile engine cylinder head. The engine cylinder head is manufactured from a normal aluminum alloy or the like and is formed from an intake port 101 for supplying intake air to the combustion chamber and an exhaust port for exhausting the exhaust gases after combustion. Each of the ports 101 and 102 is opened and closed by a valve 103, and in addition, there is a concave part 104 provided at the end of each of the ports 101 and 102; to assure airtightness of the valve and durability, a ring-shaped valve seat 105 made of iron or other sintered material is inserted into this convex part 104. It is preferable that this valve seat 105 and the convex part 104 be joined without a gap, but because of errors and the like in manufacturing, a small gap G actually arises. Furthermore, since the desired engine performance cannot be obtained if this gap G becomes large, the width of this gap G must be measured accurately, and bad products that have a gap of a fixed value or greater must be rejected. This gap G is present on the inside surface of the cylinder head 2 as shown in the drawing, and it cannot be observed directly with the eye. Therefore, conventionally, a method where an operator manually inserts a shim made of from a thin plate material into the gap G and, if the shim goes in, judges that a gap G of that thickness is present has been used widely. However, this method is greatly affected by the proficiency level of the operator and lacks objectivity, and further, since it is a manual operation, it is difficult to inspect all products.

Inspection of the width between the side surface of the concave part formed on the inside surface of this cylinder head 2 and determination of the width thereof by the surface inspection apparatus of the present embodiment are carried out as follows. First, in a state where the valve 103 has not been attached, the outer casing 11 of the surface inspection apparatus 1 is disposed such that the axial line of the cylinder head 2 and the axial line C of the outer casing 11 match in the port being inspected, either the intake port 101 or the exhaust port 102, and the light projection/receiving part 30 comes to the position 105 of the valve seat. Moreover, FIG. 6B shows the case where the surface inspection apparatus 1 is inserted into the intake port 101. Next, the sensor head 10 is moved by the sensor head adjustment mechanism 14 shown in FIG. 2, and the light L is focused on the inner surface of the cylinder head 2. By this means, the light from the LD 24 passes through the projection optical fiber 20, is condensed by the convex lens 23, arrives at the reflecting mirror 31, has its path changed to a right angle and is projected onto the inspection region R on the inner surface of the valve seat 105 from the light projection/receiving part 30.

When the rotating mechanism 12 and the linear movement mechanism 13 are driven in this state, the light from the projection optical fiber 20 is sequentially projected onto the inner surface of the cylinder head 2, and the light reflected from the entire circumference of the inner surface is received by the light receiving fiber 21. Furthermore, the outer casing 11 rotates and progresses in the axial direction C, and inspection may be carried out in a prescribed region from the inner surface of the valve seat 105 to the inner surface of the cylinder head 2.

The reflected light L passes through the light projection/receiving part 30, is bent at a right angle by reflecting mirror 31, is condensed by the convex lens 23 and is received by the receiving optical fiber 21. Since in this case, the surface of the cylinder head 2 is comparatively smooth, there is specular reflection of the majority of the light projected from the projection optical fiber 20, and it is received by the receiving optical fiber 21. Since the surface of the valve seat 105 is rougher than the inner surface of the cylinder head 2, effects of light scattering appear if the projection optical fiber 20 is made fine and the diameter of the exposure spot is made small. In the groove G part, the light scattering is even greater than in the valve seat 105 part, and there is almost no specular reflection of the light.

Here, the receiving surface area is expanded by having four receiving optical fibers 21 disposed around the projection optical fiber 20 and the diameter of the projection optical fibers 21 larger than the projection optical fiber 20. Therefore, it is possible to increase the amount of light received by the receiving optical fibers 21 from the valve seat 105 part, but on the other hand, the amount of light received from the groove part is not increased. Therefore, the difference between the valve seat surface part and the groove part becomes clear.

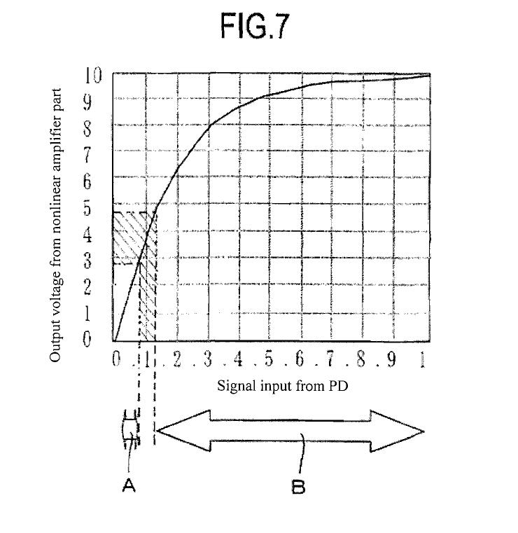

Next, the signal described above that is obtained via the receiving optical fiber 21 while scanning the inner surface of the cylinder head 2 in a spiral shape undergoes photo-electric conversion by the PD 25 and is amplified by the nonlinear amplifier 4. FIG. 7 is a graph showing the relationship between the signal that is input to the nonlinear amplifier 4 from the PD 25 and the output voltage after the nonlinear amplification by the logarithmic amp of the nonlinear amplifier 4. The part shown by A in FIG. 7 is the signal part from the PD 25 for the groove part. On the other hand, the part shown by B in FIG. 7 includes the signal from the PD 25 for the valve seat part and is the signal part for parts other than the groove. Here, a certain amount of difference arises in the signal part A from the groove and the other signal parts B in the signal input from the PD 25 because of the increasing of the light receiving surface area of the receiving optical fibers 21 as described above, but if the difference can be increased further, the two may be distinguished even more clearly. On the other hand, this differing part depends on the position where the signal out of the entire input signal is small. Therefore, by logarithmically amplifying the signal input from the PD with a nonlinear amp or a logarithmic amp, this differing part is expanded and the difference in the output voltage between the two increased, and the discrimination of the surface grooves or scratches from surface roughness or stain becomes even easier. In addition, when a fast Fourier transform device, a low-pass filter and an inverse Fourier transform device or a low-pass filter is disposed after the logarithmic amp, the effects of light scattering by surface roughness and stain that often appear in high frequency regions and the effects of other types of noise are eliminated.

This output voltage is sampled according to the sampling clock generated by the encoder 5 and undergoes A/D conversion in the A/D converter 6. Furthermore, a two dimensional image such that the inner surface of the cylinder head 2 is opened through conversion to grid image data, with the circumferential direction of the cylinder head 2 as the x-axis and the axial direction as the y-axis, by the display control means 44 of the computation processing part 8 may be obtained. Since the sampling signal is generated directly by the encoder attached to the rotating mechanism here, it is possible to synchronize the rotation of the light and the data for the received light, and it is hard for the two dimensional image to be affected by variations in rotation.

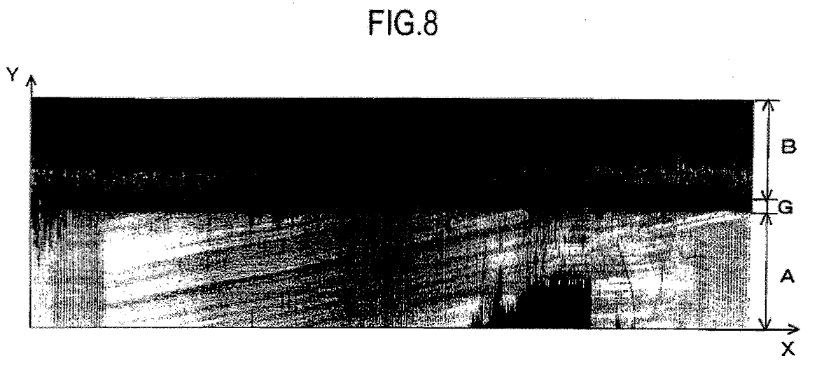

FIG. 8 is a two-dimensional image where the part of the inside surface of an air cylinder where a valve seat is attached has been inspected by a surface inspection apparatus 1 according to an embodiment of the present invention. In the figure, A is the inside surface of the cylinder head 2, and because the surface is comparatively smooth, most of the amounts of reflected light are white. In addition, B in the figure is the inner surface of the valve seat 105, and since the surface of this part is rougher than the inner surface of the cylinder head 2, the amount of reflected light is small, and it is blackish. In the drawing, G is a space between the cylinder head 2 and the valve seat 105, and since there is almost no reflected light from this part, it is black. Moreover, though it is not shown in the drawing, the inner surface of the cylinder head 2 would be completely white in a similar two-dimensional image in the case of a conventional surface inspection apparatus without a plurality of receiving optical fibers and with linear amplification, and the valve seat 105 and groove parts would both be completely black, indistinguishable from each other. However, according to this surface inspection apparatus of the present embodiment as is shown in FIG. 8, a clear difference arises between valve seat part B the groove part G, and both can be distinguished.

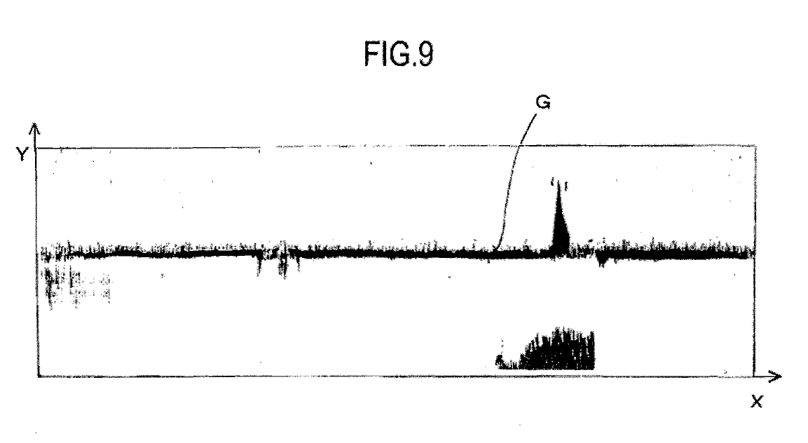

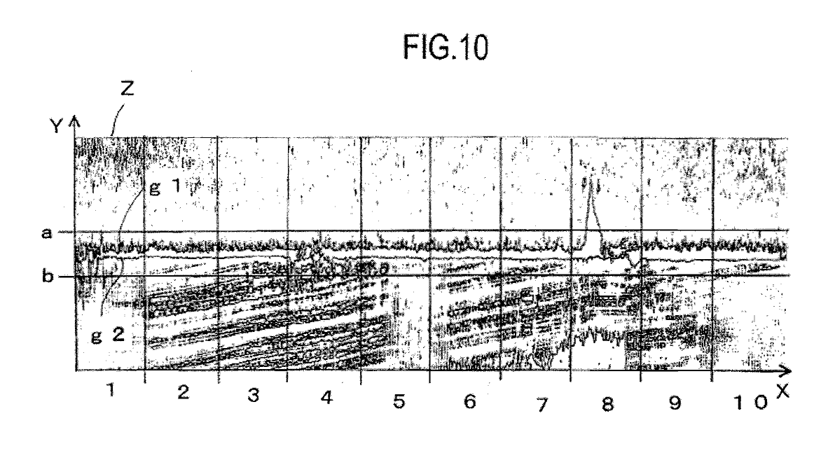

To more clearly identify the groove G, the brightness of the picture elements in the image in FIG. 8 is computed and a threshold value is set between the brightness of the groove G part and the brightness of the valve seat B part; binary processing is carried out where picture elements with a brightness greater than the threshold value are set to white picture elements, and below the threshold value, the picture elements are set to black. FIG. 9 is an image of change through this process, and the groove G may be clearly identified. Furthermore, that image undergoes edge processing, and FIG. 10 displays the one edge part g1 and the other edge part g2 of the groove G with black dots. Moreover, this binary processing and image processing are discretionary, and the coordinates of the edge parts of the groove G may be found directly from the data in FIG. 5 as described above without carrying out these processes.

Next, this image is divided into 1-10 sections along the x-axis as shown in FIG. 10 (S1). Furthermore, within the first section Z, the x-coordinate is fixed at one point, the black point corresponding to the one side part g1 searched for from the position of y-coordinate a in the drawing toward the groove, and the y-coordinate of that point found and recorded (S2). Next, the black point corresponding to the other side part g2 is searched for from the position of the y-coordinate b in the drawing toward the groove, and the y-coordinate for that point is found and recorded (S2). In this case, there are points that do not correspond to the edges of the groove among the y-coordinates because of the effects of noise and the like, but they are suitably eliminated.

Furthermore, the coordinate with the most points out of the plurality of single point y-coordinates found (S4, S5) for the prescribed number of both side parts in the first section Z is set as the representative coordinate for the one side part (S6). Likewise, out of the plurality of y-coordinates for the other point that are found, the coordinate with the most points is set as the representative coordinate for the other side part (S7). Next, the difference between the representative coordinate for the one side part in the representative coordinate for the other side part is found, and that value is set as the representative groove width for the first section (S8). Furthermore, the same computations are carried out for the second section through the tenth section (S9, S10), and the representative width for each section is found. The representative width for each section of the groove G may be determined automatically and objectively by the groove width determination means 46 of the present embodiment above.

Moreover, there are cases when, for example, the valve seat is in at a slant and the groove width will not be fixed. In such cases, the average value will be obtained when the groove with is calculated for the entirety of the circumferential direction, but there are cases when the maximum groove width is more of a problem than the average value. Because calculations are done with a division into a plurality of equal intervals in the present embodiment, it is possible to find the groove width for each divided section, and the maximum groove width and minimum groove with may be found when the groove width is not fixed. In addition, a judgment as to whether the valve is slanted or not may be made. Furthermore, in this case, it is easy to understand the variations in the groove because the divisions are made with the widths in equal intervals.

According to the surface inspection apparatus 1 of the present embodiment above, the light receiving surface area of the receiving optical fibers 21 is expanded, and in addition, there is a nonlinear amplifier, so the difference between the fine gap between an engine cylinder head side surface and a valve seat side surface and surface roughness or stain of a valve seat may be made clear, and that fine gap may be clearly detected. Therefore, the surface inspection apparatus of the present embodiment may be integrated into a production line with strict inspection standards for automotive parts and the like, and product quality and throughput may be improved.

In addition, the fine gap between the side surface of the engine cylinder head and the side surface of the valve seat may be acquired as an image that can be discriminated from the surface of the valve seat and divided, and since there is a groove width determination means that has an algorithm for determining the representative groove width, the representative width may be determined for each section of the groove G automatically and objectively. Therefore, the surface inspection apparatus of the present embodiment may be used for automatically measuring the groove width in the valve seat in automotive manufacturing lines, for example. Furthermore, since the groove width may be automatically and objectively determined in this manner, the inspection results are highly reliable, inspection of all products possible and improvement of production precision, product quality and throughput possible.

Moreover, the preferred embodiment of the present invention has been described, but the present invention is not limited by the embodiment described above, and various embodiments may be implemented. For example, as in the above, a description of a surface inspection apparatus that inspects the inside surface of a cylindrical body as the article being inspected has been given in the present embodiment, but this is not a limitation, and the surface of an article with a flat surface may also be inspected.

In the description above, there is a description of the surface inspection apparatus of the present embodiment in the case where the gap between a concave part formed in the inside surface of an automobile engine cylinder head and a ring-shaped valve seat forcefully inserted into that concave part is observed and that groove width is determined, but this is not a limitation. For example, the cylindrical body 2 need not be a cylinder head, and the groove may be the inspection of a groove or the like present in the axial direction C on the inside surface of the cylindrical body, a scratch or groove present in any direction on the inside surface, or a gap. In addition, when the groove width was found in the present embodiment, the groove was divided in the direction of its length and the representative groove width found within each divided region, but this is not a limitation, and a representative width may be determined for the entirety without division, or the groove width may be found at only one point of the groove.

According to the surface inspection apparatus above, the difference between fine grooves and scratches on the surface and surface roughness or stain may be made clear, and grooves and scratches may be detected clearly. Therefore, for example, incorporation into automotive parts and other production lines with strict inspection standards and use for inspection of minute defects are possible. In addition, in a surface inspection apparatus provided with a groove width determination means having an algorithm that finds the groove width of grooves formed on the inside surface of the cylindrical body, the groove width may be determined in-line in the production process where inspection of the inside surface is necessary and bad products eliminated, and all products may be inspected. Therefore, product precision and throughput may be improved.

1. A surface inspection apparatus that receives, through receiving optical fibers, reflected light from light from a light source projected onto the surface of an article being inspected through a projection optical fiber and inspects the surface of the article being inspected based on the amount of that light received, wherein
a plurality of the receiving optical fibers are disposed around the projection optical fiber and the diameter of the receiving optical fibers is greater than the diameter of the projection optical fiber.

2. The surface inspection apparatus according to claim 1 wherein the light received through the receiving optical fiber undergoes photo-electric conversion, and there is provided a nonlinear amplification means that nonlinearly amplifies an electric signal after photo-electric conversion.

3. The surface inspection apparatus according to claim 2 wherein the signal after photo-electric conversion is a voltage signal, and the amplification of the nonlinear amplification means is large in the low-voltage parts and small in the high-voltage parts.

4. The surface inspection apparatus according to claim 3 wherein there is provided a logarithmic amp as the nonlinear amplification means.

5. The surface inspection apparatus according to claim 2 wherein the surface of the article being inspected is the inside surface of a cylindrical body, and there are further provided a rotation means that rotates the light projected from the projection optical fiber along the inside periphery of the cylindrical body, a linear movement means that is moved in the axial direction of the cylindrical body, a clock signal generation means that generates a clock signal corresponding to the rotation of the rotation means, and an A/D conversion means that carries out A/D conversion of the amplified electric signal in synchrony with the clock signal.

6. The surface inspection apparatus according to claim 1 wherein the article being inspected is an engine cylinder head, the surface of the article being inspected the inside surface of that cylinder head and the grooves and scratches gaps between the side surface of a concave part provided on the inside surface and the side surface of a valve seat inserted into the concave part.

7. A surface inspection apparatus provided with an inspection part that has a light projection/receiving part, the inspection part being inserted into the inside of the cylindrical body that is being inspected, there being advancement relative to the direction of the axial line along with the relative rotation of the inspection part centered on the axial line of the cylindrical body, the reflected light being received while light is projected onto the inside surface of the cylindrical body by the light projection/receiving part, and a two-dimensional image corresponding to that inside surface based on the amount of light is generated, wherein
to find the width of a groove present on the inside surface of the cylindrical body, the two-dimensional image is represented by the coordinates of the groove in the direction of length and the coordinates of the groove in the direction of width,
the coordinate in the direction of length is fixed and a point corresponding to one edge part of the groove, where the amount of light exceeds a specified threshold value, and the width coordinate at another point corresponding to the other edge part of the groove are found while moving along the coordinates in the direction of width, and
there is a groove determination means having an algorithm for finding the groove width for the section from the width coordinate for the one point and the width coordinate of the other point.

8. The surface inspection apparatus according to claim 7, wherein a range of at least one part of the groove in the direction of length is set as the target section, and within the section, the coordinate of the one point in the direction of width and the coordinate in the direction of width of the other point are each found for a plurality of coordinates in the direction of length,
out of the coordinates in the direction of width for the one point for each of the coordinates in the direction of length, the coordinate in the direction of width that has the most points is made the representative coordinate for one side edge part,
out of the coordinates in the direction of width for the other point found for each of the coordinates in the direction of length, the coordinate in the direction of length that has the most points is made the representative coordinate for the other side edge part, and
the groove width for the section is set as the difference between the representative coordinate for the one side edge part and the representative coordinate for the other side edge part.

9. The surface inspection apparatus according to claim 8 wherein the section is a plurality of sections.

10. The surface inspection apparatus according to claim 9 wherein the sections are equal intervals.

11. The surface inspection apparatus according to claim 7 wherein the groove described above is present along the circumferential direction of the inside surface of the cylindrical body, the direction of the width of the groove is the axial direction for the cylindrical body, and the direction of the length of the groove is the circumferential direction of the inside surface of the cylindrical body.

12. The surface inspection apparatus according to claim 7 wherein the cylindrical body is an internal combustion engine cylinder head for a vehicle, and the groove is a gap between a side surface of a valve seat inserted into a concave part provided on the inside surface of the cylinder head and the side surface of the concave part.

13. The surface inspection apparatus according to claim 7 wherein the groove described above is present along the axial direction of the inside surface of the cylindrical body, the direction of the width of the groove is the circumferential direction for the cylindrical body, and the direction of the length of the groove is the axial direction of the inside surface of the cylindrical body.

14. The surface inspection apparatus according to claim 7 wherein the two-dimensional image is an image generated by a signal where the signal based on the amount of light received is processed by a Fourier transform, has the high-frequency components cut off, and is further processed by an inverse Fourier transform.

15. The surface inspection apparatus according to claim 7 wherein the two dimensional image is an image generated by a signal where the signal based on the amount of light received is processed by a low-pass filter.
